(19) United States
(12) Patent Application Publication
(10) Pub. No.: US 2026/0079695 A1
(43) Pub. Date: Mar. 19, 2026

(54) ARTIFICIAL INTELLIGENCE DECISION MODELING FOR GAUGING IMPACT OF SOURCE CHANGE ON DEPENDENT SYSTEMS

(71) Applicant: International Business Machines Corporation, Armonk, NY (US)

(72) Inventors: Satrajit Chatterjee, Kolkata (IN); Amlan Dhow, HOWRAH (IN); Santanu Ghosh, Kolkata (IN)

(21) Appl. No.: 18/887,454

(22) Filed: Sep. 17, 2024

(51) Int. Cl. G06F 8/71; G06Q 10/0637

(52) U.S. Cl. CPC G06F 8/71; G06Q 10/06375

(57) ABSTRACT

Mechanisms are provided for representing impacts of changes to objects in a computing system on dependent objects of the computing system. Metadata from monitored computing devices of the computing system is collected, where the metadata is associated with objects of the computing devices. A user and object metadata and relation repository (UOMRR) is generated from the metadata, where the UOMRR comprises a lineage graph that represents a dependency of the objects. A change request is received for changing a resource of a computing device in the monitored computing devices. A source object is identified in the lineage graph corresponding to the change request, and paths in the lineage graph corresponding to the source object are identified. Impact scores are calculated for each of the paths, where the impact scores quantify an impact of the change request on dependent objects of the corresponding path.

### BACKGROUND

The present application relates generally to an improved data processing apparatus and method and more specifically to an improved computing tool and improved computing tool operations/functionality for providing artificial intelligence decision modeling for gauging the impact of source changes on dependent systems.

With increased digitization and frequency of the advent of new technologies, organizations possess multiple disparate systems both in on-premises computing systems and in cloud-based computing environments. These disparate computing systems and resources are tightly integrated with each other, sharing different objects with each other physically and/or virtually in a spiderweb-like interdependence. Thus, it is difficult to get an accurate holistic view of the state of a complex cloud-based computing environment, let alone have a good understanding of the intricate interdependence of the various components of the environment.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for representing impacts of changes to objects in a computing system on dependent objects of the computing system. The method comprises collecting metadata from one or more monitored computing devices of the computing system, where the metadata is associated with one or more objects of the one or more computing devices. The method also comprises generating a user and object metadata and relation repository (UOMRR) comprising a lineage graph data structure that represents a dependency of the one or more objects. In addition, the method comprises receiving a change request for changing a resource of a computing device in the one or more monitored computing devices. Moreover, the method comprises identifying a source object, in the one or more objects, in the lineage graph data structure corresponding to the change request, and identifying one or more paths in the lineage graph data structure corresponding to the source object. Furthermore, the method comprises computing one or more impact scores for each of the one or more paths, where the one or more impact scores quantify an impact of the change request on dependent objects of the corresponding path. The method also comprises generating a report output representing the one or more impact scores of each of the one or more paths in association with the change request.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a Source Change Impact Identification and Quantification (SCIIQ) system in accordance with one illustrative embodiment;

FIG. 3 is an example diagram of a user and object metadata and relation repository (UOMRR) and the sources of data to populate the UOMRR in accordance with one illustrative embodiment;

FIG. 4 is an example diagram illustrating dependency of objects for generation of a lineage graph data structure in accordance with one illustrative embodiment;

FIG. 5 is a diagram illustrating an example of content of a Reactive Change History Registry (RCHR) in accordance with one illustrative embodiment;

FIG. 6 is an example diagram illustrating a workflow for machine predicting an organization impact score via a machine learning computer model in accordance with one illustrative embodiment;

FIG. 7 is an example diagram illustrating a data structure for representing the scores and weightings associated with paths in accordance with one illustrative embodiment;

FIG. 8 is an example diagram illustrating the messages output to decision makers and recommended actions in accordance with one illustrative embodiment;

FIG. 9 is a flowchart outlining an example operation of a SCIIQ system in accordance with one illustrative embodiment;

FIG. 10 is a flowchart outlining an example operation for identifying objects impacted by a change based on a user and object metadata and relation repository (UOMRR) in accordance with one illustrative embodiment; and

FIG. 11 is a flowchart outlining an example operation for determining an impact score in accordance with one illustrative embodiment.

### DETAILED DESCRIPTION

The illustrative embodiments provide an improved computing tool and improved computing tool operations/functionality for providing artificial intelligence decision modeling for gauging the impact of source changes on dependent systems. With the increased configuration of organization computing systems in such a way that these systems and associated resources are interdependent on each other, a change in one system may affect multiple dependent systems. It is increasingly difficult for the owners or decision makers associated with such interdependent computing systems to understand the impact of changes in their computing system due to a change in another computing system. Thus, an automated system to inform owners/decision makers of the impacts of changes in computing systems on other computing systems/computing resources and presenting such information in an easily consumable manner would be greatly beneficial. Moreover, an automated system that is able to quantify the impacts would assist owners/decision makers in determining the severity of such impacts.

However, some of the challenges to providing such an automated system include the maintaining of history data of changes and their impact as well as obtaining information regarding the technical objects and their metadata source from the computing systems in a useable form. That is, to address the above issues, rigorous analysis of connected objects, i.e., artifacts which exchange data among themselves (e.g., programs, interfaces, batch jobs, reports, and the like), across different computing systems may need to be performed in order to determine the impact of a change. Moreover, a user and object metadata and relation repository (UOMRR) having a list of technical objects and their metadata sourced from the disparate computing systems of an organization is another important component.

The illustrative embodiments provide an automated artificial intelligence computing system solution to the above issues and provides an improved computing tool and improved computing tool operations/functionality to automatically determine the impacts of changes to computing systems/computing resources on other interdependent computing systems/computing resources and provides a mechanism for quantifying and presenting this impact information to owners/decision makers. The solution provided by the improved computing tool and improved computing tool operations or functionality of the illustrative embodiments allows owners/decision makers to quickly make decisions knowing the volume of the impact and exact impacted objects, as well as react quickly to ensure limited, or preferably no, negative impacts to the organization or users of the organization's computing systems and resources.

In some illustrative embodiments, improved computing tool mechanisms and functionality are provided which identifies and quantifies the volume of changes and impacts in dependent systems and their resources (hereafter referred to simply as dependent systems) due to a change in a source system. This identification and quantification is performed based on change details mentioned in a change request, history data of impact in other systems, and a central repository system with object lineage and user information. The resulting identification and quantification may drive notifications, user interface representations, and the like, to inform decision makers to thereby make them aware of the impact of a change so that they may take appropriate reactive or preemptive measures to ensure limited or no impact on users or systems that rely on the identified impacted dependent systems. The automatic identification and quantifying of such impacts on dependent systems allows decision makers to be quickly informed of the impacts of requested changes prior to such changes being implemented to thereby quickly limit the impact through reactive or preemptive measures.

In accordance with one or more of the illustrative embodiments, a Source Change Impact Identification and Quantification (SCIIQ) system is provided that automatically determines an impact score of impacted objects and paths, based on a source change request, with the assistance of history data of impacts maintained in a Reactive Change History Repository (RCHR) in dependent systems, and a User and Object Metadata and Relation Repository (UOMRR) centrally maintained for all systems. The SCIIQ system implements one or more trained machine learning (ML) computer models that are trained through machine learning training processes to determine an Organization Impact Score (OIS), Usability Score (US), and Change Complexity Score (CCS) for the impacted path. The SCIIQ system further includes mechanisms for generating a consolidated impact score (CIS) for each impacted path. Based on the number of paths affected, a Final Impact Score (FIS) is determined for the requested change. The SCIIQ system may also provide a text message with recommended action(s) in a drill down capable report or prompt which can be further analyzed to know the scores for the individual impacted paths, e.g., the IS, US, CCS, and/or CIS, making the decision makers of a system enabled to take quick and informed decision with little or almost no effort spent.

It should be appreciated that in modern computing systems, especially large scale computing systems involving many different individual computing devices, having many different applications, data structures, and other resources, and potentially involving many different cloud-based computing systems, resources, services, and the like, the interdependencies of all the components of the computing system may not be able to be perceived completely in a holistic manner by manual efforts or human effort. Due to human limitations, some interdependencies may be overlooked or missed entirely.

For example, assume that there is a generative artificial intelligence (Gen AI) project running with user stories created across various hyperscalars and enterprises. The Gen AI board generates monthly releases for user stories across each such product pillar. Say on an average there are 5 assets per pillar and for each month, enhancement work is being done for 9 pillars for each asset. There are 9*5=45 assets being worked upon every month. Any enhancement in an asset must access, on an average, 15 objects for each change within the enhancement. A conservative estimate is 5 changes per asset per month.

Thus, the number of objects that need to be assessed=(no of pillars*no of assets*no of enhancements per asset*no of objects that need to be analyzed per enhancement) 9*5*5*15=3375 objects for all pillars consolidated. This is for one month. Thus, a release manager will need to spend their budget wisely to see which changes are more important. To do a qualitative assessment the release manager will have to run through this exercise with each asset for each pillar and each month. However the release manager is plagued with the problem that the assessment to apply an importance to the change is subjective and not everybody assessing might have used the same understanding to come up with the importance. It is prone to human errors and bias since every team would like to go ahead with their changes and feels that their changes should take priority. The nature of the problem is exacerbated by the exponential increase in the number of objects to be analyzed and also by the fact the human evaluation is subjective. Thus, it is not practical for human beings to address such issues with regard to implementing requested changes due to their limitations and biases and doing so with appropriate insights for determining the impact of these requested changes.

The improved computing tool of the illustrative embodiments leverages artificial intelligence mechanisms, e.g., machine learning computer models and additional computing logic, to automatically identify and quantify impacts of requested changes to a source computing system or resource (object) on dependent systems/resources. These impacts may include impacts on dependencies not readily perceivable to human beings due to the complexities of the interdependencies of the computing systems and resources involved.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides mechanisms for identifying and quantifying the impact of requested changes to a source system, i.e., a source impacted system, on dependent systems and provides reporting of the quantified impacts to decision makers to assist with mitigating impacts on dependent systems. The improved computing tool implements mechanism and functionality, such as the Source Change Impact Identification and Quantification (SCIIQ) system, which cannot be practically performed by human beings either outside of, or with the assistance of, a technical environment, such as a mental process or the like. The improved computing tool provides a practical application of the methodology at least in that the improved computing tool is able to automatically identify and quantify impacts of requested changes to a source computing system or resource (object) on dependent systems/resources through specific application of artificial intelligence, e.g., machine learning computer models, which are trained to identify and quantify such impacts which may include impacts on dependencies not readily perceivable to human beings due to the complexities of the interdependencies involved.

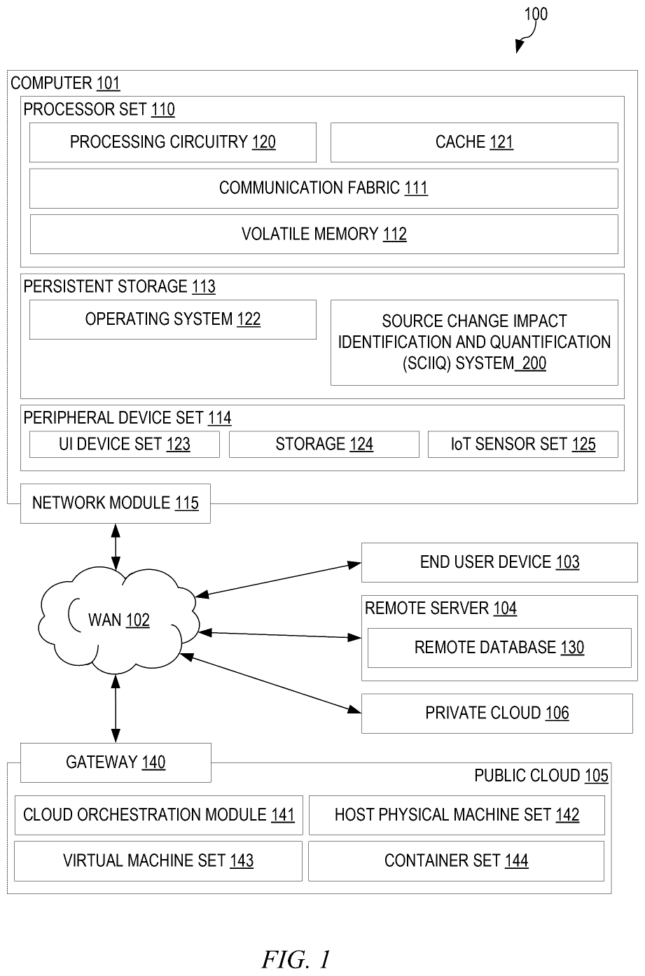

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as Source Change Impact Identification and Quantification (SCIIQ) system 200. In addition to SCIIQ system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and SCIIQ system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in SCIIQ system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in SCIIQ system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a SCIIQ system 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated artificial intelligence based identification and quantification of change impacts from changes to a source system on dependent systems in a complex interdependent computing system having many disparate computing systems and resources provided in a distributed and/or cloud based infrastructure.

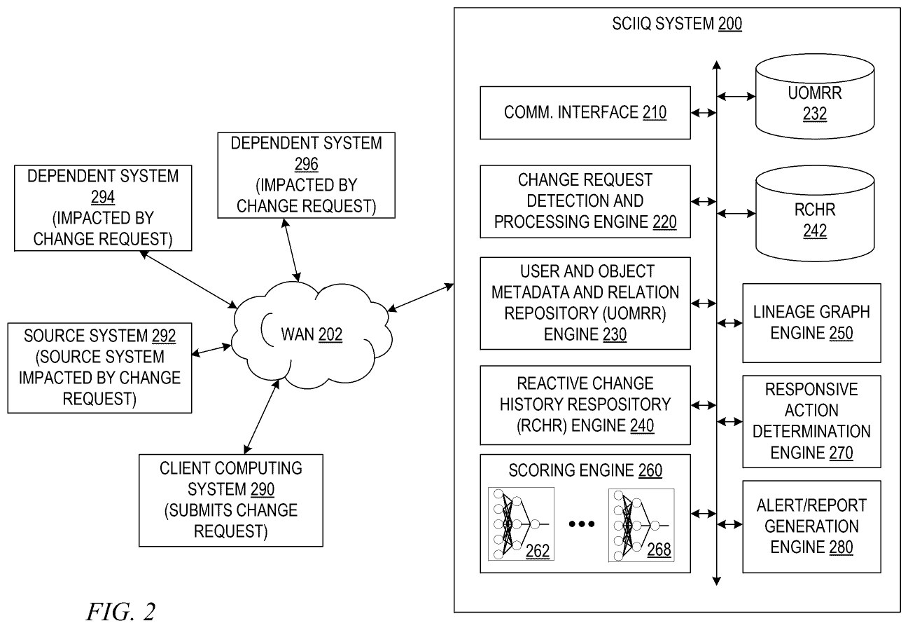

FIG. 2 is an example block diagram illustrating the primary operational components of a Source Change Impact Identification and Quantification (SCIIQ) system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., change requests, and the resulting output may aid human beings, e.g., textual messages, user interfaces, and the like, that represent the automatically predicted impacts of source system changes as well as recommended actions to mitigate such impacts. The invention is specifically directed to the automatically operating computer components directed to improving the way that complex interdependent and potentially distributed computing systems are managed and changes to source systems are implemented, and providing a specific solution that automatically identifies and quantifies, via specifically configured and trained artificial intelligence mechanisms, the impacts of changes on dependent systems/resources, which cannot be practically performed by human beings as a mental process and is not directed to organizing any human activity.

As shown in FIG. 2, the SCIIQ system 200 comprises a communication interface 210, a change request detection and processing engine 220, a user and object metadata and relation repository (UOMRR) engine 230 and corresponding UOMRR 232, a reactive change history repository (RCHR) engine 240 and corresponding RCHR 242, a lineage graph engine 250, an impact scoring engine 260 comprising one or more trained machine learning computer models 262-268, a responsive action determination engine 270, and an alert/report generation engine 280. It should be appreciated that these are the primary operational components of the SCIIQ system 200 and other logic and components, e.g., operating system, libraries, storage, memories, and the like, may be present to facilitate the operations of the SCIIQ system 200 described herein but are not explicitly depicted in the figures. It should also be appreciated that while FIGS. 1-2 are depicted with the various components of the SCIIQ system 200 being implemented within a same computing system, e.g., in the same server computing system, the illustrative embodiments are not limited to such and the components may be distributed across a plurality of computing systems but may operate in conjunction with one another to achieve the functionality of the SCIIQ system 200 described herein.

As shown in FIG. 2, the communication interface 210 provides the logic and computer resources needed to provide data communications between computing systems and the SCIIQ system 200 via one or more wired and/or wireless data networks, such as wide area network (WAN) 202, for example. In some illustrative embodiments, the WAN 202 may comprise the Internet, one or more cloud computing system networks, local area networks combined, and/or combined with other networks, to provide a wide area network, or the like. In the depicted example, the communication interface 210 provides a data communication functionality for communicating with client computing system 290, source system 292, dependent system 294, and dependent system 296. These systems 290-296 may be separate physical and/or virtual computing system instances on the same or different physical computing machines which may be local or remote from each other. These systems 290-296 may be associated with a same organization such that there may be an interdependency between these systems, such as previously discussed above, such that some systems 294-296 may be dependent on other systems, e.g., 292, and/or on each other. It should also be appreciated that this example is simplified for ease of explanation, and that the organization will in reality comprise many more such systems 290-296 than those shown in the present diagram, and thus, the complexities of the interdependencies may be significantly increase beyond that shown in the present diagram.

The communication interface 210 provides a data communication pathway whereby various components of the SCIIQ system 200 may automatically, and continuously or periodically, monitor and gather information from the various monitored computing systems 290-296. For example, the change request detection and processing engine 220 may monitor the computing systems 290-296 for change requests, the UOMRR engine 230 may execute a daemon process to monitor and collect user and object metadata as well as determine relations between these objects with the aid of the lineage graph engine 250 which are then represented in a graph data structure of the UOMRR 232, and the RCHR engine 240 may execute a daemon process to monitor and collect change history information from the computing systems 290-296 for creating and maintaining the RCHR 242. The data collected and maintained by the engines 230 and 240 in the UOMRR 232 and RCHR 242 may be used by one or more of the trained machine learning computer models 262-268 of the scoring engine 260 to score objects and paths in the lineage graph so as to determine impacted objects and quantify the impact for determination of responsive action recommendations by the responsive action determination engine 270 and the generation of alerts/reports via the alert/report generation engine 280.

Thus, the impact scoring of the SCIIQ system 200 utilizes the UOMRR 232 and RCHR 242 as a basis for determining the pathways of dependent objects and the parameters for scoring the objects and pathways. Hence, the generation of these data structures will first be described prior to further discussion of the scoring performed.

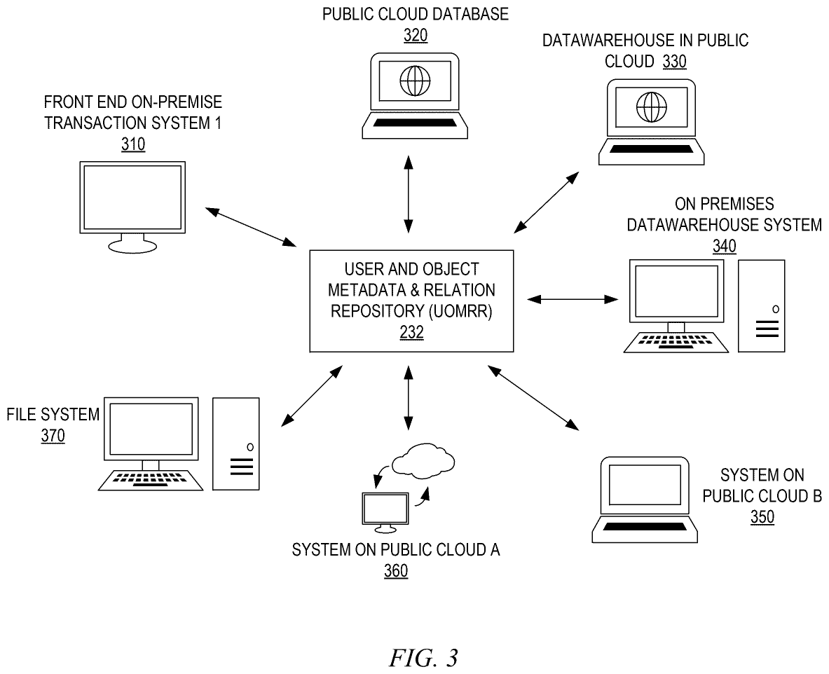

As noted above, the UOMRR engine 230 operates to generate and maintain the UOMRR 232. Moreover, as discussed hereafter, the UOMRR engine 230 further provides computing logic and resources for performing a specific searching of the UOMRR 232 to identify impacted pathways in response to a detected change request. FIG. 3 is an example diagram of a UOMRR 232 and the sources of data that are monitored to populate the UOMRR 232 in accordance with one illustrative embodiment. As shown in FIG. 3, the UOMRR 232 may be generated by communicating with, and collecting from, various computing systems, the user information and metadata for the objects associated with those computing systems. These computing systems may take many different forms, such as the examples shown in FIG. 3 and others. For example, the computing systems from which user information and object metadata information may be collected include frontend on-premise transaction systems 310, public cloud databases 320, data warehouses in public clouds 330, on-premise data warehouse systems 340, systems on public clouds 350 and 360, file systems 370, and the like. The computing systems 310-370 may be associated with a particular organization such that the computing systems 310-370 together may constitute a computing environment for that organization. The computing systems 310-370 may be configured with software agents, applications, or the like, which are specifically configured to perform monitoring of the computing system 310-370 to collect data locally and then report that data to the SCIIQ system 200 continuously or periodically, such as in response to a request from the engines 230, 240 or the like.

The object metadata may be provided in product provided metadata schema. System tables, for example, may store information about the data, e.g. table information, object reference as parent child, and the like, with this data being able to be extracted using Structured Query Language (SQL) queries or the like. The UOMRR 232 stores: a) Object Metadata and Relationship information in the form of parent-child; and b) user information of users who have access to these objects. The user information may include a classification of the type of the user, e.g., super-user, regular user, etc., as well as other user information helpful in evaluating the impact of a requested change. For example, as will be evident in the description hereafter, the user information may be used to quantify an organization impact score (OIS) for a given requested change.

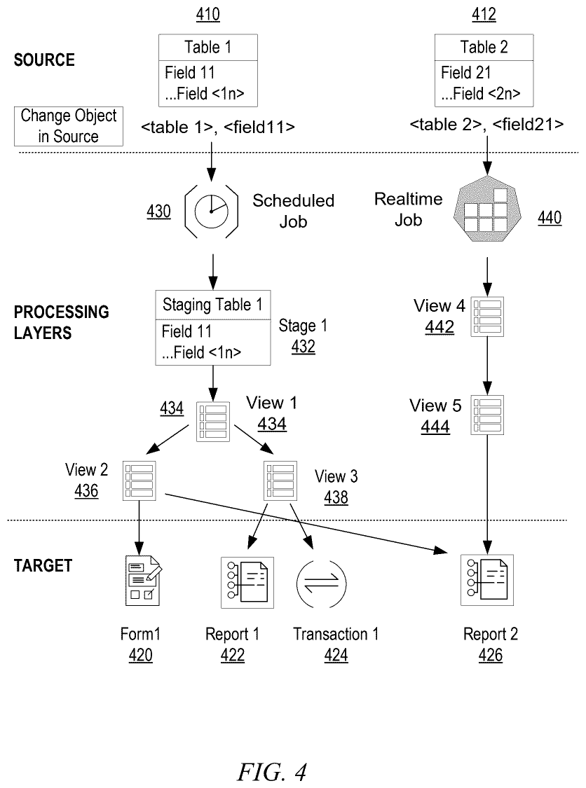

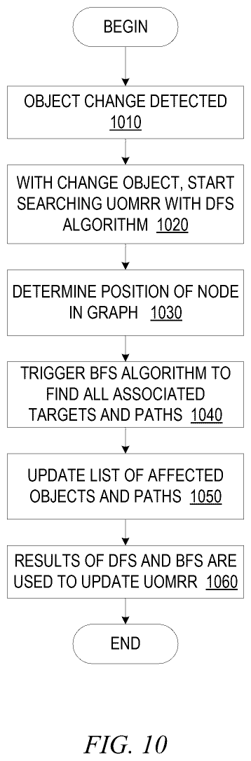

The UOMRR engine 230, in building and maintaining the UOMRR 232, keeps track of all the objects across the organization's computing system environment, e.g., objects on each of the computing systems 310-370 in FIG. 3, and the relationships among them. This may be accomplished through a process where metadata is built from all source and target computing systems. A source system is one which records a change in object metadata, e.g., a change in code, a change in a structure of a database object, etc. The target system is one which is the recipient of the data from the source system and can be potentially affected by any changes in the source system. The source and target systems are differentiated in the figures by directional flow of data with an origin as the source and an endpoint as the target, e.g., see FIGS. 4 and 10 hereafter. Depending on the context, a system can act as both a source system and a target system.

A lineage graph engine 250 is used to build a lineage graph detailing the relationships between each source and each target system in a dependency graph type data structure. This allows for the creation of object dependency paths between the source systems and target systems, which identify the dependent objects that may be affected by a change to an object in the lineage graph. The lineage graph data structure(s) serve as a basis for the creation and maintaining of the information in both the UOMRR 232 and the RCHR 242 as will be apparent from the following description.

FIG. 4 is an example diagram illustrating dependency of objects for generation of a lineage graph data structure in accordance with one illustrative embodiment. FIG. 4 will first be described in the context of a generation of the lineage graph data structure and then, hereafter, will be discussed again to illustrate how a change in a source object may be identified and used to determine the impact of that change on dependent objects using the lineage graph data structure, which may be created and maintained in the UOMRR 232.

As shown in FIG. 4, there are two separate lineage graphs associated with each of the source objects 410 and 412. In the depicted example, source object 410 is a first table data structure, i.e., table 1, and the source object 412 is a second table data structure, i.e., table 2. Based on the user and object metadata gathered by the UOMRR engine 230, e.g., fields of metadata of objects, showing dependencies between objects and the like, of objects implemented on the various monitored computing systems of the monitored organization computing environment, it is determined that target objects 420-426 are reached from the source objects 410, 412 via the processing layers comprising dependent objects 430-444. Thus, it can be determined from the metadata that points to related objects that source object 410 has a related job scheduling object 430, which has a related staging table object 432, which provides a view 1 object 434, and which has further view object 2 436 and view object 3 438. These views 436 and 438 further have dependent target objects 420-424.

A similar lineage graph can be generated for the source object 412 and target object 426, as well as each other pairing of source and target objects in the organization's computing system environment. These lineage graph data structures may be maintained in the UOMRR 232 and may be used to identify which dependent objects are potentially affected by a change to a source object. For example, given a source object identifier, each target object pairing may be identified for that source object identifier and the corresponding lineage graph data structure retrieved from the UOMRR 232. From the retrieved lineage graph data structures, each dependent object may be identified by traversing the lineage graph data structures.

Thus, for example, a job scheduling object 430 may be implemented when the source object 410 is changed, which then causes a change in the staging table object 432. This may cause changes in view 1 object 434, which in turn may cause a change in view 2 object 436 and/or view 3 object 438. This may then affect the target objects including form1 object 420, report1 object 422, and transaction object 424. Similarly, a change to the table 2 object 412 may affect dependent processing layer objects 440-444 and target object 426. Thus, for example, there are three layers of source, processing, and target, with 410, 430, and 420 being objects of each layer respectively. The path 410→430→432→434→436→420 shows how the data flows from the source object 410 to the target object 420 using intermediate objects (430→432→434→436). The graph in FIG. 4 is a representation of object metadata lineage (relation between predecessor & successor.

The UOMRR 232 can be maintained by the UOMRR engine 230 to keep track of all kinds of objects across the computing systems 290-296 and the relationships among them. Metadata is available as part of information schema maintained by the source computing systems 290-296 and may be extracted by monitoring agents or engines and provided to the SCIIQ system 200, for source objects, target objects and all the processing layer objects (in the example of FIG. 4, a three layer architecture of source, processing layer, and target are shown, but other architectures may utilize more or fewer layers). The UOMRR engine 230 gathers this metadata from the computing systems 290-296 regarding the sources, targets, and processing object, and the lineage graph engine 250 generates the lineage graph that is represented in the UOMRR 232. Additionally the user details of target objects are also maintained in the same repository.

In the depicted example of FIG. 4, the different paths which connect the source object to the target object are the lineage paths for the entire graph. In the example diagram above, the source fields which got changed are <table1>.<field11> and <table2>.<field21>. The impacted lineage paths are as follows:

$$〈 table 1 〉 \cdot 〈 field 11 〉 - Scheduled Job - Stage 1 - View 1 - View 2 - Form 1$$

$$〈 table 1 〉 \cdot 〈 field 11 〉 - Scheduled Job - Stage 1 - View 1 - View 3 - Report 1$$

$$〈 table 1 〉 \cdot 〈 field 11 〉 - Scheduled Job \text{} - Stage 1 \text{} - \text{} View 1 - \text{} View 3 - T ransaction 1$$

$$〈 table 2 〉 \cdot 〈 field 21 〉 - Realtime Job - View 4 - View 5 - Report 2$$

$$〈 table 1 〉 \cdot 〈 field 11 〉 - Scheduled Job - Stage 1 - View 1 - View 2 - Report 2$$

The graph representation of objects as nodes and connections between objects as paths, such as shown in FIG. 4, may be utilized to build a faster search mechanism using graph algorithms, such as depth first search (DFS) and breadth first search (BFS).

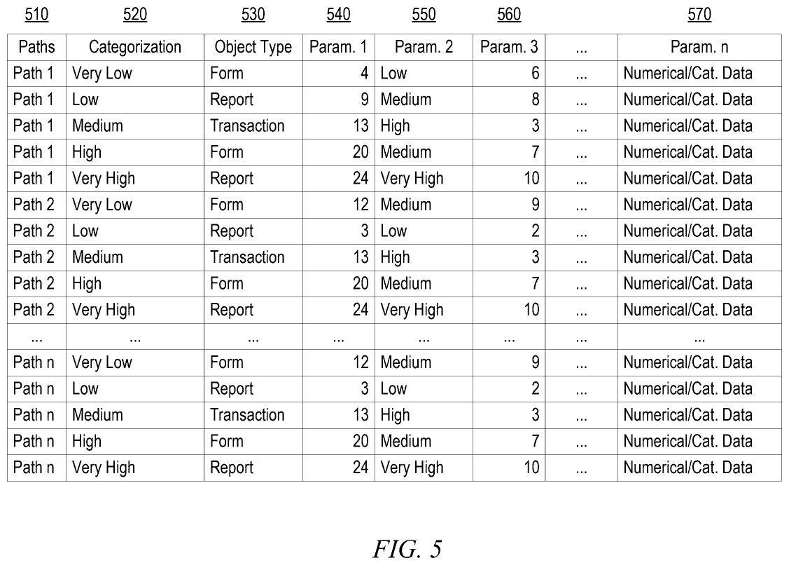

In addition to the UOMRR 232 generated and maintained by the UOMRR engine 230, the RCHR engine 240 may monitor and interact with the monitored computing systems 290-292, via the communication interface 210, to gather historical change impact data from these computing systems 290-292 for populating fields of the RCHR 242. The RCHR 242 is built and updated, based on the lineage graph data structure(s), after the scoring by the scoring engine 260 as described hereafter, e.g., the generation of an organization impact score (OIS), usability score (US), and change complexity score (CCS). The RCHR 242 may serve as training data for machine learning algorithms and is generated from a system which records change history that was labeled manually. For example, for any change ticket in a service management tool, such as JIRA™ from Atlassian, ServiceNow® available from ServiceNow Inc., etc. the independent variables can be recorded, e.g., Modify Column name, Modify Column description, Add column, Object Type, etc. and a user categorization of the importance of the change may also be recorded. For example in the table of FIG. 5, which may have been recorded from JIRA data, the target/dependent variable that is to be predicted is the categorization in column 520 and depends on the Object Type 530 and Parameters 1 to n 540-570, i.e. independent variables. Essentially, the illustrative embodiments model the categorization 520 as a function of independent variables. For any new change ticket the illustrative embodiments will use this labeled data repository to train/validate the model and then use it for prediction.

As described herein, the example table of FIG. 5 will apply for RCHR repository construction of Organization Impact Change (OIC) and Change Complexity (CCS) scoring since the target variables are categorical in nature using machine learning classification techniques for prediction of these target variables (Categorization column for Organization Impact Change and similarly for Change Complexity). As discussed herein, the Usability Impact target variable is quantitative in nature and has a numerical value (e.g. how many times accessed within a period). Thus, the illustrative embodiments would construct the numerical parameters for the RCHR repository from Usage Statistics Schema (part of any data management system).

The combination of these scores OIS, US, and CCS provides an impact score (IS) for a change to a source object. The scoring is based on the different parameters specified by the particular organization as the principle parameters for use in scoring, as may be specified in configuration information for the scoring engine 260. These parameters may include, but are not limited to, the following. For OIS, the parameters may include number of large objects (LOBs) impacted, number of applications impacted, type of users impacted (regular user, super user, etc.), number of objects impacted, number of users impacted, criticality of the application, system/application-level service level agreement (SLA) defined, and regulatory compliance impacted. For US, the parameters may include, but are not limited to, a number of users that use the objects and a number of times the object was accessed within a period of time. For CCS, the parameters may include, but are not limited to, various table modification parameters, e.g., parameters describing the addition of a new table, parameters describing alterations of a table, parameters associated with dropping a table, parameters associated with changing a program, or the like. Table 1 hereafter provides an example of some of these parameters that may be used to generate the CCS for a database change complexity scoring:

TABLE 1
Examples of CCS Parameters for a Database Change

| CC High Level | | |
|---|---|---|
| Parameters | CC Detail Parameters | Level |
| Database | | 1 |
| Change | | |
| Complexity | | |
| | Add new table | 2 |
| | Alter table | 2 |
| | Changes in columns | 3 |
| | Add column | 4 |
| | Modify column | 4 |
| | Modify column name | 5 |
| | Modify column description | 5 |
| | Modify column length | 5 |
| | ... | 5 |
| | Delete column | 4 |
| | Change in table | 3 |
| | Rename the table | 4 |
| | Change in table properties | 4 |
| | Drop Table | 2 |
| | ... | . . . |
| | Change in program | 2 |
| | Logic change in program | 3 |
| | Change in coding for maintaining best practices | 3 |
| | ... | . . . |

As can be seen from the example shown above, there may be multiple levels of change complexity score (CCS) parameters. In one or more illustrative embodiments, the CCS scoring may be performed with regard to one or more of the lowest levels of parameters of each subtree of parameters, e.g., if a subtree of parameters has levels 4 and 5, only CCS scores for level 5 parameters may be generated. This may be performed similarly with regard to the other scores as well, i.e., the OIS and US scores. Table 2 shows an example of the CCS scoring for the lowest levels of parameters in accordance with one illustrative embodiment.

TABLE 2
Example of CCS Scoring at Lowest Parameter Level

| CC High Level | | | |
|---|---|---|---|
| Parameters | CC Detail Parameters | Level | CCS |
| Database | | 1 | |
| Change | | | |
| Complexity | | | |
| | Add new table | 2 | Very |
| | | | Low |
| | Alter table | 2 | |
| | Changes in columns | 3 | |
| | Add column | 4 | Low |
| | Modify column | 4 | |
| | Modify column name | 5 | High |
| | Modify column description | 5 | Very |
| | | | Low |
| | Modify column length | 5 | Very |
| | | | High |
| | ... | 5 | . . . |
| | Delete column | 4 | Very |
| | | | High |
| | Change in table | 3 | |
| | Rename the table | 4 | High |
| | Change in table properties | 4 | Medium |
| | Drop Table | 2 | |
| | ... | . . . | |
| | Change in program | 2 | |
| | Logic change in program | 3 | High |
| | Change in coding for maintaining best | 3 | Very |
| | practices | | Low |
| | ... | . . . | |

During training, the RCHR 242 provides information that specifies, for particular inputs, e.g., organization impact, usability statistics, and change complexity, the parameters and their complexity (e.g., numerical or label/category) and object type from the historical data of change impacts.

The RCHR 242 further has the categorization data of change impact score for corresponding OIS, US, and CCS of a path in the lineage graph data structures. Thus, the RCHR 242 is a combination of the parameters with individual complexity, object type for a target object, and categorization of OIS, US, and CCS for pathways from the source object to that target object. Thus, the RCHR 242 may store entries of this type for each source object and target object pairing, and each source object/target object pairing may have a separate entry for each path associated with that source object. In some illustrative embodiments, there may be a separate RCHR 242 for each source object/target object pairing.

The RCHR 242 may provide training data for training the machine learning computer models 262-268 in FIG. 2. That is, to train the machine learning computer model, one needs training data that has been manually annotated or labeled with the target variable, e.g., Categorization 520 in FIG. 5. This manually annotated or labeled dataset is used as training/validation data to create the ML model using classification and regression. With the illustrative embodiments, a new change ticket is received that does not have any manually assigned target variable, e.g., Categorization 520. The trained ML model is used to predict the target variable, the organization impact category, change complexity category, and usability score. Thus, the RCHR 242 is used as training data to train the machine learning computer model.

An example visual representation of the contents of an RCHR 242 is shown in FIG. 5. As shown in FIG. 5, the RCHR 242 includes the various paths 510 for the source object to corresponding target objects having various object types 530. The categorization 520 specifies a categorization of the change impact score, which may be a combination of the other scores OIS (categorical score), US (numerical score), and CCS (categorical score). The various parameters 540-570 are provided with the values for each of the parameters being indicators of the complexity of those parameters. It should be appreciated that there may be a separate RCHR 242 data structure for each type of scoring parameter sets, e.g., organization impact, usability statistics, and change complexity data.

Thus, for any of the sets of organization impact, usability statistics, and change complexity data for generating corresponding scoring, the RCHR 242 lists all the parameters 540-570 for an object having an object type 530 from the history of change data, along with the complexity of the change, which may be specified in terms of either a numerical value (e.g., and integer or real value) or a categorization label (e.g., low, medium, high, very high, etc.). The Object Type 530 definition specifies the type of object while traversing from source to target via the processing layers. The Object Type 530 will be “Target Object Type” if the row corresponds to the target object. However, if the object is a processing layer object, then it will have another Object Type, or regular object type, corresponding to the type of the particular object, e.g., Form, Transaction, Report, etc. As described herein, the CCS (change complexity score) refers to all the objects in Path<n>, whereas OIS refers to the target object only. However for ease of nomenclature, all the components in the Path are referred to as objects.

The RCHR 242 also specifies the categorization data 520 of the change impact score (CIS) for the corresponding organization impact, usability statistics, or change complexity for a path. Thus, the entries in the RCHR 242 comprise a combination of parameters with individual complexity, object type, and categorization of organization impact, usability statistics, and/or change complexity as it is applied for a path.

Thus, the UOMRR 232 provides a more real-time dynamic data collected from the various systems 290-296, whereas the RCHR 242 provide historic data on actual changes and their impacts with regard to the various parameters. Returning to FIG. 2, the RCHR 242 being historical data of change impacts, is used to train, through a machine learning process, the one or more machine learning computer models 262-268 of the scoring engine 260. Th RCHR 242 may be split into training and validation or testing data sets for training and testing the machine learning computer models 262-268, e.g., a major portion of the RCHR 242 may be selected for training the machine learning computer models 262-268 whereas a minor portion may be used to validate or test the machine learning computer models 262-268 to ensure that they are providing adequate performance, e.g., accuracy of predictions of scores.

The machine learning computer models 262-268 may take many different forms, such as decision trees, regression models, support vector machines, or the like. Moreover, different ones of the machine learning computer models 262-268 may be of different types from others of the machine learning computer models 262-268. The particular type of machine learning computer model to use for each instance is based on the desired implementation and suitability for each type of scoring performed by the machine learning computer model. Thus, for example, in some illustrative embodiments, a first machine learning computer model 262 may be a decision tree type machine learning computer model that is used to predict the organization impact score (OIS), a second machine learning computer model 264 may be a regression machine learning computer model (linear/non-linear) for predicting the usability score (US), and a third machine learning computer model 266 may be a Support Vector Machine (SVM) for predicting the change complexity score (CCS). A fourth machine learning computer model 268 may be utilized for generating a change impact score (CIS) based on a learned or specified weighting of the various constituent scores OIS, US, and CCS, for individual paths. Alternatively, other logic for generating the CIS based on a weighted function of the constituent scores OIS, US, and CCS may be used without departing from the spirit and scope of the present invention. The CIS may also be referred to herein as the Consolidated Impact Score.

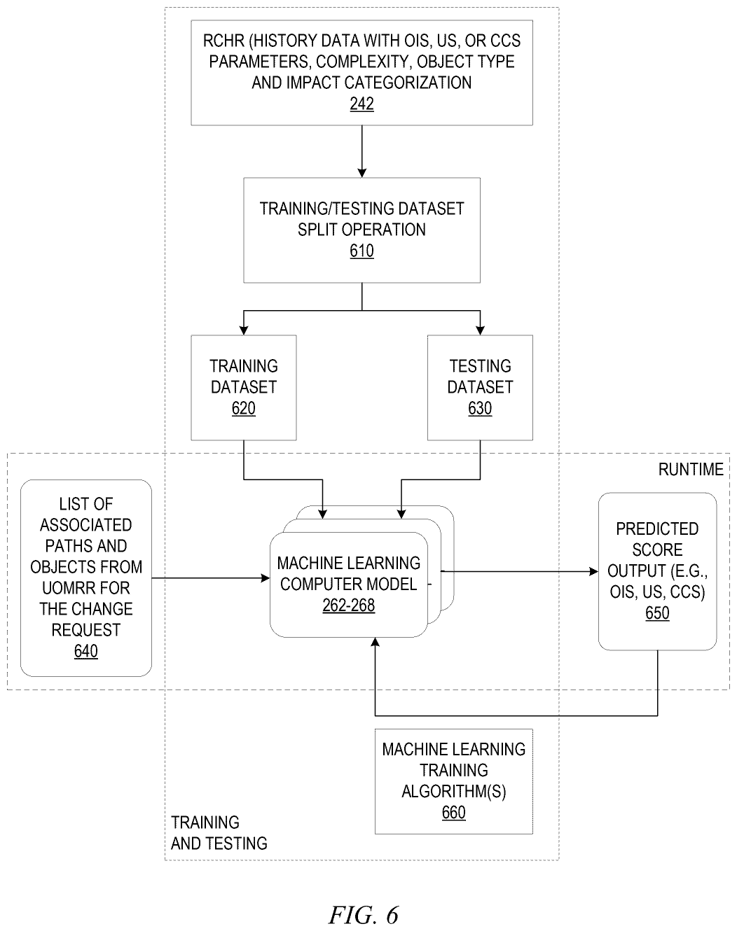

FIG. 6 is an example diagram illustrating a workflow for machine predicting scores via machine learning computer models in accordance with one illustrative embodiment. As shown in FIG. 6, when training the machine learning computer models 262-268, the RCHR 232 is split 610 into a training dataset 620 and a testing data set 630. The particular portions, or table data structures, of the RCHR 242 that are subject to the split 610 may be dependent on the particular machine learning computer model being trained. For example, for training a first machine learning computer model 262 to generate predictions of organization impact score (OIS), the portion of the RCHR 242 that is the basis of the split 610 operation is the organization impact parameters with complexity, object type, and organization impact categorization. For training a second machine learning computer model 264 to generate predictions of usability score (US), the portion of the RCHR 242 that is the basis of the split 610 is the usability impact parameters with complexity, object type, and organization impact categorization. For training a third machine learning computer model 266 to generate predictions of change complexity score (CCS), the portion of the RCHR 242 that is the basis of the split 610 is the portion with change complexity impact parameters with complexity, object type, and organization impact categorization.

The input to the particular machine learning computer models 262-266 in each case is the list of associated paths and objects from the RCHR 242/UOMRR 232 for a corresponding change request. During training of the machine learning computer models 262-266, this listing is obtained from the training data 620, and during testing from the test data 630. During runtime operation, i.e., after training of the machine learning computer models 262-266 has completed, this listing is obtained from the UOMRR 232.

During training, the training data 620 is input to the machine learning computer model, which processes the training data 620 in an iterative manner, and generates predicted scores 650. These are compared to ground truth data quantifying the historic impact of the change, and a loss is determined. One or more machine learning algorithms 660, e.g., a regression algorithm or the like, may be applied to determine a modification to the operational parameters of the machine learning computer model to reduce the loss. This process is repeated iteratively until the loss reaches a satisfactory level, e.g., equal or below a threshold loss, or a predetermined number of iterations have been performed, at which point the machine learning computer model is determined to have converged and is trained. Once trained, the testing data 630 may be input to the trained machine learning computer model in a similar fashion to again determine the accuracy and other performance statistics of the machine learning computer model for comparison to desired performance criteria. This is to ensure that even though trained, that the training resulted in a machine learning computer model that generates satisfactory results.

Once trained, the trained machine learning computer models are executed on lists of associated paths and objects from the UOMRR 232 for a particular runtime change request. The trained machine learning computer models 262-266 generate their corresponding scores and/or categorizations based on their training and the input features from the UOMRR 232. In particular, for one or more illustrative embodiments, a first machine learning computer model 262 is trained to generate a predicted organization impact score (OIS) in terms of categorization for individual objects and paths of the input to the first machine learning computer model 262. A second machine learning computer model 264 is trained to generate a predicted usability score (US) in terms of categorization of number of individual objects and paths of the input to the second machine learning computer model 264. A third machine learning computer model 266 is trained to generate a predicted change complexity score (CCS) in terms of categorization of individual objects and paths of the input to the third machine learning computer model 266.

The prediction of the various scores may generate numerical and/or categorical score outputs depending on the particular machine learning computer model and the desired implementation. For example, for OIS generation, the trained machine learning computer model may output numerical values of a predefined scale, such as 1-10, and/or may output a category along a spectrum of categories, such as a spectrum comprising categories of extremely low, very low, low minimum, low maximum, medium, more than medium, slightly high, high, very high, and extremely high. The same or different score ranges and/or categorization spectrums may be used for each of the different trained machine learning computer models 262-268 and their corresponding score outputs.

Thus, assuming the machine learning computer models 262-268 of the scoring engine 260 have already been trained through the machine learning training process discussed above, the change request detection and processing engine 220 operates to detect change requests to change one or more systems or resources of one or more of the systems 290-296 and process such change requests. That is, in some illustrative embodiments, the systems 290-296 may be registered with the SCIIQ system 200, may have agent applications executing on the systems 290-296, or have other instrumentation or monitoring mechanisms implemented to detect a request to perform a change in a computing system, such as source system 292. In other illustrative embodiments, a client computing system 290 may request a change to another computing system or resource, e.g., computing system 292, and this change request may be routed to the SCIIQ system 200 for processing based on a predefined configuration. A change request is one which entails all such actions which would lead to a change in source object metadata. The action which can lead to this metadata change (e.g. change in datatype, length of the datatype, field rename, database key definition, etc.) can be modification of file, changing a configuration, etc. In short, any such action (quantifiable as a “Change Request” as raised via a Service Management tool) would lead to a change in data or data structure. This change is what will trigger the impact score computation of the illustrative embodiments.

Thus, the change request detection and processing engine 220 may, in some illustrative embodiments, continuously monitor an organization's computing systems to detect whether there is any new change request raised in any of the computing systems 290-296 of the organization's computing environment. If any new change request is detected by the change request detection and processing engine 220, the change request detection and processing engine 220 detects which objects in the source system 292 are affected by the requested change from the documentation submitted during the change request process.

For example, assume that there is a Systems Applications and Products (SAP) transactional screen where a user fills all the excise tax information related to a sales order. Now the government of the particular country has mandated to include the production plant information, like address, in that SAP screen. The address currently shows only the country code. Now the field needs to show also the full address (street, zip code, etc.). This calls for a change in the length of the field to accommodate additional data. This is the change in the source system data structure. Additionally if there is a tax compliance report, which used to show the country code of production plant, this would now show truncated information since the source system field length of the address has changed. Only when the report breaks, would one know about this issue. The illustrative embodiments address this by preempting and computing an assessment of this impact quantitatively.

Thus, once the change request is detected and processed by the engine 220 in the manner described above, the UOMRR engine 230 searches the UOMRR 232 for paths of associated objects via searching logic. For example, the UOMRR engine 230 comprises the computing logic and resources required to build and maintain the UOMRR 232 as well as perform searches of the UOMRR 232 to identify objects associated with an object affected by a change request.

Assuming the UOMRR 232 are built and maintained by the UOMRR engine 230, with the assistance of the lineage graph engine 250 to generate the lineage graph in order to identify dependencies between source and target systems and corresponding objects, when a change is detected by the change request detection and processing engine 220 of the SCIIQ system 200, the UOMRR engine 230 performs a search within the UOMRR 232, such as a depth-first search (DFS) of the lineage graph representation in the UOMRR 232. The specification of the change is correlated to an object in the lineage graph representation of the UOMRR 232. The corresponding object is the basis for the performance of a search of the UOMRR 232 by the UOMRR engine 230, such as a depth-first search, which locates the affected object(s), i.e., the object(s) in the source systems, e.g., source systems 292-296 that are affected by the requested change, and then performs a secondary search to identify each path associated with the affected object(s) in the graph. For example, this secondary search may be a breadth-first search (BFS) that traverses the lineage graph representation of the UOMRR 232 aiming to identify all nodes and their corresponding paths (lineage) associated with the node corresponding to the affected objects.

The results of the primary and secondary searches are compiled into a table of search result information that serves as an initial input to the scoring engine 260, encapsulating a comprehensive list of nodes and their associated paths. This table data structure becomes foundational for the subsequent procedures, laying the groundwork for informed decision making and further system operations. The coordination of the primary and secondary searching operations ensures a thorough exploration of the UOMRR 232, facilitating an efficient and comprehensive understanding of the changes and their relationships within the graph structure.

With the help of information derived from the UOMRR 232, e.g., the impacted paths with objects, the scoring engine 260 uses the trained machine learning computer models 262-268 to determine the individual impact scores for every impacted path, and a final score of impact for all the paths. As noted above, the individual impact scores for every impacted path may comprise the OIS, US, and CCS for the objects along the path and an CIS for the path. That is, each of the trained machine learning computer models 262-268 operate on the input data from the UOMRR 232 for the affected paths and generates a predicted corresponding score, e.g., OIS, US, CCS, such that each affected path now has these three scores associated with them. To understand the overall impact of the path, a single consolidated score may be generated using a learned or specified weighting of the various constituent scores, where the weights may be different for different ones of the scores. Thus, for example, the change complexity score may be considered higher than the organization impact score for the change for an impacted path. This weighting may be determined through a machine learning process where the weights may be adjusted until the machine learning computer model 268 that generates the consolidated score, or CIS, generates sufficiently accurate consolidated scores based on the ground truth data from the RCHR 242.

Alternatively, the weighting may be specified by the particular organization based on the organization's goals, vision, and policies. In one example situation, an organization may set the weight of the OIS to 50%, the weight of the US to 30%, and the weight of the CCS to 20%. The consolidated impact score, or CIS, may be calculated based on a function that uses the weightings learned or specified. For example, in one illustrative embodiment, the CIS may be a weighted sum of the different constituent scores. For example, the function for calculating the consolidated impact score may be:

$$CIS = ( OIS ⋆ OIS weight ) + US ⋆ US weight ) + CCS ⋆ CCS weight ) \qquad ( 1 )$$

Of course in other illustrative embodiments, the function may take other forms with different operations and values, e.g., weighted averages, weighted mean value, etc. In one or more illustrative embodiments, any function that generates an average of the scores may be used without departing from the spirit and scope of the present invention.

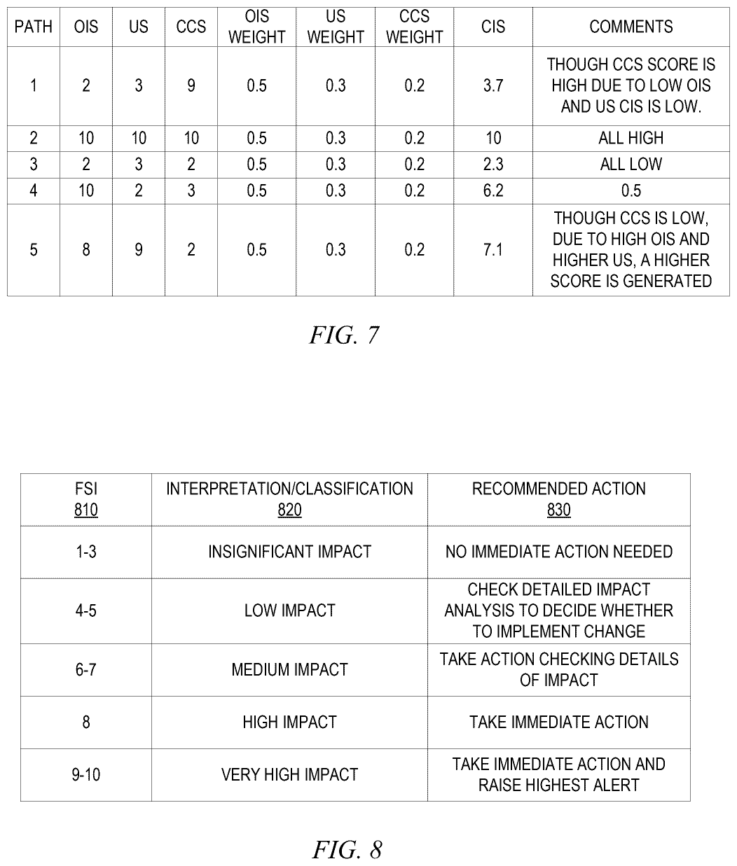

FIG. 7 is an example diagram illustrating a data structure for representing the scores and weightings associated with paths in accordance with one illustrative embodiment. Using FIG. 7 as an example, if a given path, e.g., Path 1, has an OIS of 2, a US of 3, a CCS of 9, a OIS weight of 0.5, a US weight of 0.3, and a CCS weight of 0.2, then using the above function, the consolidated impact score, or CIS, for the path may be 3.7, which is on a scale from 1 to 10. In this case, although the CCS score is high and the BIS is low, the weightings cause the overall consolidated impact score to be low. In other words, the path's consolidated impact score is low because of the low usability and even lower organization impact of a change to this path.

Based on the consolidated impact scores for the various affected paths, a final score of impact (FSI) may be determined. The FSI may be calculated as the average of the consolidated impact score, or CIS, of the affected paths, or other desirable function of the combination of consolidated impact scores for the affected paths. For example, FSI may be calculated using the following function:

$$FSI = ( CIS of path 1 + CIS of path 2 + CIS of path 3 … + CIS of path n ) / n \qquad ( 2 )$$

where n is the number of impacted paths. Thus, for example, if there are 5 affected paths with the consolidated impact scores of 3.7, 10, 2.3, 6.2, and 7.1, then the FSI for this combination of affected paths given the above function (2), would be 5.86. It should be appreciated that the function (2) is only an example and other functions that quantify the combination of the consolidated impact scores of the affected paths may be used without departing from the spirit and scope of the present invention.

The FSI provide an indication of the impact of a change request. The FSI value may be used to generate a classification or category label for the change impact which may also be correlated with a recommended action. That is, the FSI for the affected paths may be provided to, or generated by, the responsive action determination engine 270. Based on the FSI, a corresponding classification may be generated based on a predetermined scale of classifications. The classification provides an interpretation of the numerical FSI value. FIG. 8 is an example diagram illustrating an example illustrative embodiment of the correlation between FSI, classifications, and recommended actions, which may be correlated to messages output to decision makers and recommended actions. As shown in FIG. 8, various FSI ranges 810 are defined with corresponding classifications 820 of the impacts and corresponding recommended actions 830. It should be appreciated that this is only an example and other correlations between FSI values and interpretations and recommended actions may be established and utilized.

In some illustrative embodiments, the FSI is a numerical value normalized to a scale of 1-10 and may be determined by an average of Consolidated Impact Score (CIS) for each impacted path. As shown in FIG. 8, different ranges within the scale may correspond to different interpretations, e.g., an FSI of 1-3 may be considered an “insignificant impact”, FSI of 4-5 may be a “low impact”, a FSI of 6-7 may be a “medium impact”, etc. Various rules may be established for determining, based on OIS, US, CCS, and FSI score, the particular actions that are recommended to be taken.

For example, a first rule may specify that if the FSI score is greater than or equal to a predetermined value, e.g., 8, then the change is determined to have high or very high impact. Thus, a recommended action is to implement the change. A second rule may be that if the FSI is less than the predetermined value, then a corresponding recommendation of an action may be generated based on the particular FSI score. With regard to the second rule, OIS may be given higher precedence weighting than US, which in turn has a higher precedence weighting than CCS, e.g., 0.5>0.3>0.2.

Thus, for the second rule, for each impacted path, a larger OIS will mean that the path is a candidate for change. Any OIS greater than or equal to the predetermined value, e.g., 8, takes precedence over other scores (stating the fact that this needs to be done irrespective of US and CCS). Any OIS less than the predetermined value would imply to look at the next score, i.e., US. Again, a US greater than or equal to the predetermined value would result in the path being a candidate for change. If the OIS and US are both less than the predetermined value, e.g., 8, then the CCS may be checked to determine if its complexity score is less than a second predetermined value, e.g., 5, indicating low complex changes. If the CCS is less than this second threshold, then the path may be marked as a candidate for implementing the change.

Rule 2-c: If OIS<8 and US<8, then check if CCS<5 (low complex change). The path will be marked as candidate for change. Thus, in summary for each path:
OIS>8=>Change (high organization impact)
OIS<8 and US>8=>Change (high usability impact)
OIS<8 and US<8 and CCS<5=>Change (not high organization impact and not high usability impact, but low change complexity).
   For all other scenarios, the impact is summarized, such as in the comments column of FIG. 7. The summarization is done referring to the same ranges in column 810 of FIG. 8 and using the text from column 820, e.g., a path score (OIS=7, US=5, CCS=6) will be summarized in the last column of FIG. 7 as (Medium, Low, Medium).

For example, applying these example rules to the example shown in FIG. 8, and using the acronyms VL—very low, L—low, M—medium, H—high and VH—very high and a representation of (OIS, US, CCS), one obtains the following:

$$Path 1 - 3.7 - ( VH , VL , VH )$$

$$Path 2 - 10 - ( VH , VH , VH )$$

$$Path 3 - 2.3 - ( VL , VL , VL )$$

$$Path 4 - 6.2 - ( VH , VL , VL )$$

$$Path 5 - 7.1 - ( H , VH , VL )$$

Based on the rules defined above, the FSI is 5.86, which implies checking Rule 2 above. Path 2, Path 4 and Path 5 are direct change candidates as defined in Rule 2. Path 1 and Path 3 have majority very low impact due to change, and hence can be tagged as no change required.

It should be appreciated that the OIS and US values should be on the higher side and the CCS should be on the lower side in order to tag an impacted path as a candidate for change. The boundary values (e.g., >8 and <5), which define the rules are configurable and can be set to different values depending on the desired implementation. While the above automated mechanism is a rule based approach, other approaches, such as machine learning inference and the like, can be used to evaluate the various scores and determine a recommended action. Moreover, while the action recommendation is generated automatically by the mechanisms of the illustrative embodiments, it should be appreciated that tools may be provided to allow the organization or a user to override the automated rule based recommendations for each path.

Based on the classification of the FSI and the recommended action, the responsive action determination engine 270 determines a responsive action to take. The determined responsive action may be communicated to the alert/report generation engine 280 along with the classification of the FSI, and other details of the analysis of the effects of the change on the various affected paths so that they may be reported in one or more alerts or reports for decision makers. The alert/report may have multiple levels of detail. For example, at a first level, the classification of the FSI and the corresponding recommended action may be output in the alert/report so as to inform the decision maker as to whether they should investigate the change more before implementing the change in their computing systems 290-296. The decision maker may then drill down further into the alert/report through graphical user interface elements or the like, to access more detailed levels of the alert/report to obtain information regarding affected paths, constituent scores, objects involved in each path, and the like. The alert/report may be repeatedly provided to the decision maker until the requested changes are accepted or rejected, at which point the process may be terminated.

Thus, the SCIIQ system 200 provides an improved computing tool and improved computing tool operations/functionality for quantifying the effects of a change on a computing system or computing system resources, e.g., objects, with regard to dependent objects. The impact of the change may be quantified and classified so as to provide decision makers with information to make decisions regarding the implementation of such changes based on their determined classification of impact. The SCIIQ system 200 may generate alerts/reports with information regarding the quantification and classification of these impacts as well as recommended actions for decision makers to perform when determining whether to implement a requested change. The determination of the impact of a requested change may be evaluated along multiple dimensions included organization impact, usability impact, and change complexity impact.

In some illustrative embodiments, object level impact scoring is provided in which, for every impacted path, the impact on the organization is quantified (e.g., the OIS), the impact on users is quantified (e.g., the US), and the complexity of the change being requested is quantified (e.g., the CCS), which provides an evaluation of not only the organization impact but also the cost of the impact in terms of usability and complexity to implement the change. In some illustrative embodiments, path level scoring is also implemented. While object level scoring helps in understanding the impact on objects individually, in path level scoring, e.g., using weighted combinations of the object level impact scoring, provides an understanding of the overall impact quantification for an individual path. In some illustrative embodiments, final impact scoring is performed in the case where there are multiple affected paths. That is, if changes impact multiple paths, consolidating the scores of the various affected paths to determine a final impact score (FIS) allows for quantification of the impact of a change across all paths which helps decision makers to evaluate and judge the organization and cost perspective of a change.

While most of the impact scoring may be based on the organization impact, the illustrative embodiments also quantify the complexity of the change implementation which would assist decision makers in understanding the financial impact, though indirectly, for correction needed to implement the changes in target computing systems which are required to embrace the impact of changes to a source computing system. The illustrative embodiments provide mechanisms to not only provide the final score of impact to help decision makers to understand the overall impact of a change, but also to assist decision makers in taking the appropriate action by providing actionable insight as an alert message, graphical user interface, or the like, having recommendations based on classifications of the final impact scores for the changes.

The precision of the impact scoring (ability to quantify the qualitative impact as numbers) assists decision makers to make quick decisions regarding selection of the changes to be implemented in target computing systems. This precise impact scoring assists decision maker in prioritizing the changes for implementation more easily and in a shorter amount of time, while referring to the detailed drilled down impact data for further informing of decision makers. The SCIIQ system 200 of the illustrative embodiments, in providing this precision impact scoring, leverages machine learning training and machine learning computer models to learn how to evaluated various features of affected objects/paths to generate a corresponding score for one or more of the various dimensions.

To illustrate this further, consider one of the computing systems, of an organization with diversified product portfolio, is a data warehouse system where data is fed from multiple other computing systems. At the beginning of each month a consolidated finance report may be built of the last month based on the data from the multiple computing systems. If there is any change in any of the source systems, it may affect the report adversely and may often raise high priority tickets attracting unwanted attention and causing dissatisfaction of end users. Unfortunately, there is no existing way for decision makers to quickly know what the impact of any change that may be occurring in one of the many source systems will be, or the volume of the impact of the changes on the report will be, until the change adversely affects the end users.

However, implementing the mechanisms of the illustrative embodiments, the decision makers of the organization are informed of the affected objects and criticality of the impact of any change in a source computing system, e.g., the data warehouse, in a proactive manner. This may be done even before the change occurs, giving the decision makers enough opportunity to implement or not implement the required changes in the data warehouse, as needed and/or desired.

As another example, assume that XYZ organization has a centralized data hub which is fed data from diverse source systems on one hand, while on the other hand, data from the data hub is the source of many other systems. Thus, any change in any of the sources of the data hub may affect multiple target systems adversely. Knowing about this consequence, the owner of the data hub may inform the owners of the target systems about any changes happening in sources on a regular basis. As per the information provided by the data hub owner, the owner of one of the target systems may take prompt action analyzing the impacted objects and criticality of the changes made. Often it is observed that all changes the data hub owner notifies the target system owners of are not worth giving so much time and attention, while a few changes are worth the time and attention required to analyze and take prompt actions. If the target system owner has access to the mechanisms of the illustrative embodiments, the target system owner may be informed about the impacted paths and objects, as well as criticality of the impact, which will assist them in determining which changes are worth the time and attention to investigate further and take appropriate action.

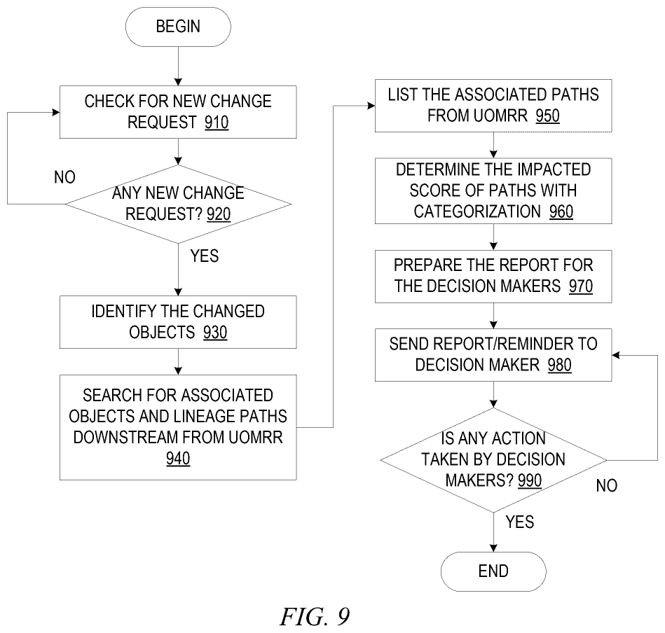

FIGS. 9-11 present flowcharts outlining example operations of elements of the present invention with regard to one or more illustrative embodiments. It should be appreciated that the operations outlined in FIGS. 9-11 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 9-11, and may, in some cases, make use of the results generated as a consequence of the operations set forth in FIGS. 9-11, the operations in FIGS. 9-11 themselves are specifically performed by the improved computing tool in an automated manner.

FIG. 9 is a flowchart outlining an example operation of a SCIIQ system in accordance with one illustrative embodiment. As shown in FIG. 9, the operation checks for a new change request from a source computing system (step 910). A determination is made as to whether a change request is detected (step 920). If not, the operation returns to step 910 to continue to check for new change requests. If a change request is detected, then the changed objects are identified (step 930). A search for the associated objects and lineage paths of downstream or dependent objects is performed using the UOMRR (step 940). A listing of the associated affected paths is generated from the UOMRR (step 950). The impact scores and classifications (or categorizations) are determined for each of the associated affected paths (step 960). A report of the impact scoring and classification for the affected paths is then prepared (step 970) and is then sent to the decision makers (step 980). A determination is made as to whether the decision makers take action on the requested change (step 990). If not, the operation returns to step 980 and continues to notify the decision makers of the report. If so, the operation terminates.

FIG. 10 is a flowchart outlining an example operation for identifying objects impacted by a change based on a user and object metadata and relation repository (UOMRR) in accordance with one illustrative embodiment. As shown in FIG. 10, the operation starts by detecting an object change (step 1010). With the changed object as a start, a search of the UMORR is performed using a depth first search (DFS) algorithm (step 1020). The position of the node is identified in the graph (step 1030) and a breadth first search algorithm is triggered to find all associated targets and paths (step 1040). The list of affected objects and paths is updated (step 1050) while the results of the DFS and BFS are stored in the UOMRR 232 to update the UOMRR 232 (step 1060). The operation then terminates.

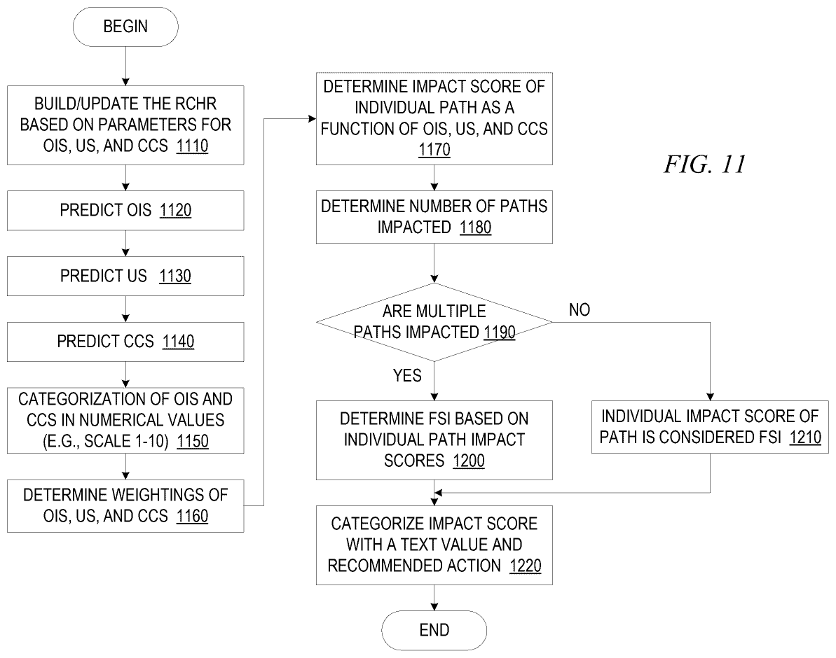

FIG. 11 is a flowchart outlining an example operation for determining an impact score in accordance with one illustrative embodiment. As shown in FIG. 11, the operation starts with the building/updating of the RCHR based on the parameters selected by the organization for OIS, US, and CCS scoring (step 1110). The OIS is then predicted for an impacted path based on the RCHR using a first trained machine learning computer model, such as a machine learning classification model, for example (step 1120). The US is then predicted for the impacted path based on the RCHR using a second trained machine learning model, such as a machine learning regression model, for example (step 1130). The CCS is then predicted for the impacted path based on the RCHR using a third machine learning computer model, such as a machine learning classification model, for example (step 1140). The CCS would be the same for all paths of a single change request. Thus, the ML models that are trained using the RCHR data are used to generate the scores, whereas the UOMRR is used to create the paths of connected objects across source, processing, and target layers.

The OIS, US, and CCS scoring may be used to generate scores/categorizations of numerical values and/or textual labels, and may be along the same or different scales (step 1050). The weighting of the different scores is determined either through a machine learning or through standard best practices and/or consultation with the organization (step 1060). The weightings are used to combine the scores in a weighted manner to generate a consolidated impact score for each path (step 1170). The number of paths impacted are then determined (step 1180) and a determination is made as to whether more than one path is impacted (step 1190). If more than one path is impacted, then a final score of impact (FSI) is generated based on a combination of the consolidated impact scores of the affected paths and is then used to generate a classification of the overall impact of the change (step 1200). If only one path is impacted, the FSI is the individual consolidated impact score for the path (step 1210). In either case, the FSI is used to classify the impact into an interpretation of the criticality of the impact and is used to obtain a recommended action which is communicated to decision makers via one or more alerts, reports, drill down graphical user interfaces, or the like (step 1220). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for representing impacts of changes to objects in a computing system on dependent objects of the computing system, the method comprising:
collecting metadata from one or more monitored computing devices of the computing system, wherein the metadata is associated with one or more objects of the one or more computing devices;
generating a user and object metadata and relation repository (UOMRR) comprising a lineage graph data structure that represents a dependency of the one or more objects;
receiving a change request for changing a resource of a computing device in the one or more monitored computing devices;
identifying a source object, in the one or more objects, in the lineage graph data structure corresponding to the change request;
identifying one or more paths in the lineage graph data structure corresponding to the source object;
computing one or more impact scores for each of the one or more paths, wherein the one or more impact scores quantify an impact of the change request on dependent objects of the corresponding path; and
generating a report output representing the one or more impact scores of each of the one or more paths in association with the change request.

2. The method of claim 1, wherein the one or more impact scores are computed by one or more trained machine learning computer models, wherein the one or more trained machine learning computer models are trained on a reactive change history registry (RCHR), which comprises historical change data specifying impacts of changes to objects on dependent objects.

3. The method of claim 2, wherein a first trained machine learning computer model is trained to generate an organization impact score (OIS) that quantifies an impact of a change to the source object on an organization associated with the computing system.

4. The method of claim 3, wherein a second machine learning computer model is trained to generate a usability score (US) that quantifies an impact of a change to the source object on users of the computing system.

5. The method of claim 4, wherein a third machine learning computer model is trained to generate a complexity of change score (CCS) that quantifies a cost of an impact of the change on implementing the change to dependent objects.

6. The method of claim 5, wherein the one or more impact scores comprises, for each path in the one or more paths, a consolidated impact score (CIS) that is a weighted combination of the OIS, US, and CCS for the path.

7. The method of claim 6, wherein the one or more impact scores comprises a final score of impact (FSI) for a combination of the CIS for all of the one or more paths.

8. The method of claim 7, wherein the method further comprises classifying the FSI into one of a plurality of classifications of criticality of an impact of the change request on the computing system.

9. The method of claim 8, wherein the report output comprises a representation of the classification of the FSI and a corresponding recommendation to a decision maker in determining whether to implement the change request in the computing system.

10. A computer program product comprising a computer readable storage medium having a computer readable program stored therein, wherein the computer readable program, when executed in a data processing system, causes the data processing system to:
collect metadata from one or more monitored computing devices of a computing system, wherein the metadata is associated with one or more objects of the one or more computing devices;
generate a user and object metadata and relation repository (UOMRR) comprising a lineage graph data structure that represents a dependency of the one or more objects;
receive a change request for changing a resource of a computing device in the one or more monitored computing devices;
identify a source object, in the one or more objects, in the lineage graph data structure corresponding to the change request;
identify one or more paths in the lineage graph data structure corresponding to the source object;
compute one or more impact scores for each of the one or more paths, wherein the one or more impact scores quantify an impact of the change request on dependent objects of the corresponding path; and
generate a report output representing the one or more impact scores of each of the one or more paths in association with the change request.

11. The computer program product of claim 10, wherein the one or more impact scores are computed by one or more trained machine learning computer models, wherein the one or more trained machine learning computer models are trained on a reactive change history registry (RCHR), which comprises historical change data specifying impacts of changes to objects on dependent objects.

12. The computer program product of claim 11, wherein a first trained machine learning computer model is trained to generate an organization impact score (OIS) that quantifies an impact of a change to the source object on an organization associated with the computing system.

13. The computer program product of claim 12, wherein a second machine learning computer model is trained to generate a usability score (US) that quantifies an impact of a change to the source object on users of the computing system.

14. The computer program product of claim 13, wherein a third machine learning computer model is trained to generate a complexity of change score (CCS) that quantifies a cost of an impact of the change on implementing the change to dependent objects.

15. The computer program product of claim 14, wherein the one or more impact scores comprises, for each path in the one or more paths, a consolidated impact score (CIS) that is a weighted combination of the OIS, US, and CCS for the path.

16. The computer program product of claim 15, wherein the one or more impact scores comprises a final score of impact (FSI) for a combination of the CIS for all of the one or more paths.

17. The computer program product of claim 16, wherein the method further comprises classifying the FSI into one of a plurality of classifications of criticality of an impact of the change request on the computing system.

18. The computer program product of claim 17, wherein the report output comprises a representation of the classification of the FSI and a corresponding recommendation to a decision maker in determining whether to implement the change request in the computing system.

19. An apparatus comprising:
at least one processor; and
at least one memory coupled to the at least one processor, wherein the at least one memory comprises instructions which, when executed by the at least one processor, cause the at least one processor to:
collect metadata from one or more monitored computing devices of a computing system, wherein the metadata is associated with one or more objects of the one or more computing devices;
generate a user and object metadata and relation repository (UOMRR) comprising a lineage graph data structure that represents a dependency of the one or more objects;
receive a change request for changing a resource of a computing device in the one or more monitored computing devices;
identify a source object, in the one or more objects, in the lineage graph data structure corresponding to the change request;
identify one or more paths in the lineage graph data structure corresponding to the source object;
compute one or more impact scores for each of the one or more paths, wherein the one or more impact scores quantify an impact of the change request on dependent objects of the corresponding path; and
generate a report output representing the one or more impact scores of each of the one or more paths in association with the change request.

20. The apparatus of claim 19, wherein the one or more impact scores are computed by one or more trained machine learning computer models, wherein the one or more trained machine learning computer models are trained on a reactive change history registry (RCHR), which comprises historical change data specifying impacts of changes to objects on dependent objects.
